(19) United States
(12) Patent Application Publication
(10) Pub. No.: US 2007/0090176 A1
(43) Pub. Date: Apr. 26, 2007

(54) Computer device with keyboard barrier

(76) Inventor: Mark S. Tracy, Tomball, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/259,428

(22) Filed: Oct. 25, 2005

(51) Int. Cl. G06C 7/02

(52) U.S. Cl. 235/145 R

(57) ABSTRACT

A computer device comprises a keyboard and an air-permeable barrier element disposed within the computer device and configured to prevent moisture migration through the keyboard.

### BACKGROUND OF THE INVENTION

Cooling of computer devices is an important design concern. One method of providing thermal energy dissipation for a computer device (e.g., in a laptop or notebook computer) is to provide a vented keyboard assembly such that ventilation through the keyboard assembly dissipates thermal energy generated by the computer device. However, if a user of the computer device spills a liquid onto the keyboard assembly, the liquid can short and/or otherwise damage electronic components disposed within the computer device.

### BRIEF DESCRIPTION OF THE DRAWINGS

For a more complete understanding of the present invention and the advantages thereof, reference is now made to the following descriptions taken in connection with the accompanying drawings in which:

FIG. 1 is a diagram illustrating an embodiment of a computer device in which a keyboard barrier in accordance with the present invention is used to advantage;

FIG. 2 is a diagram illustrating a section view of a portion of an embodiment of a keyboard barrier in accordance with the present invention taken along the line 2-2 of FIG. 1; and

FIG. 3 is a diagram illustrating a bottom view of the keyboard illustrated in FIGS. 1 and 2.

### DETAILED DESCRIPTION OF THE DRAWINGS

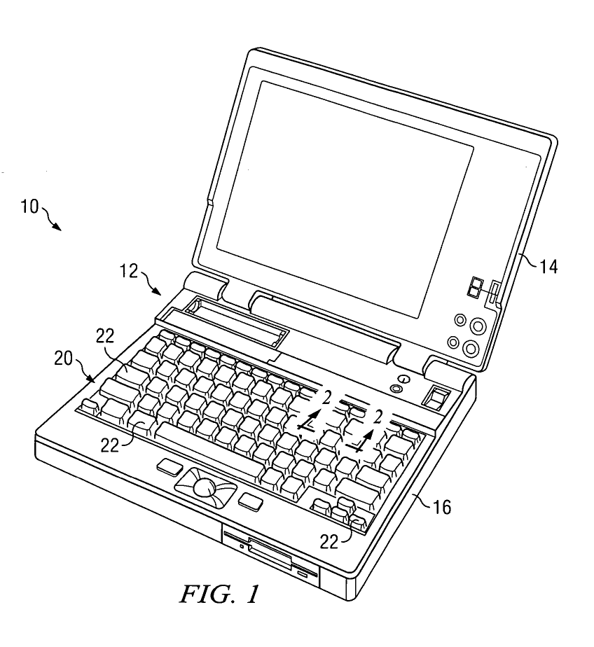

The preferred embodiments of the present invention and the advantages thereof are best understood by referring to FIGS. 1-3 of the drawings, like numerals being used for like and corresponding parts of the various drawings.

FIG. 1 is a diagram illustrating an embodiment of a computer device 10 in accordance with the present invention. In the embodiment illustrated in FIG. 1, computer device 10 comprises a laptop or notebook computer 12 having a display member 14 rotatably coupled to a base member 16. However, it should be understood that computer device 10 may comprise other types of computer and/or electronic devices such as, but not limited to, a tablet computer, personal digital assistant, or other type of portable and/or non-portable device.

In the embodiment illustrated in FIG. 1, computer device 10 comprises a keyboard 20 having key caps 22 for receiving user input thereon. In the embodiment illustrated in FIG. 1, keyboard 20 is disposed in base member 16. However, it should be understood that keyboard 20 may be otherwise located on computer device 10 (e.g., based at least on whether computer device 10 is a portable or laptop computer or other type of computing device). In operation, embodiments of the present invention prevent (e.g., prevent or substantially prevent) liquid or moisture migration through keyboard 20 which may otherwise damage or compromise electronic components within an interior cavity or location of computer device 10 (e.g., in the embodiment illustrated in FIG. 1, electronic components disposed within base member 16).

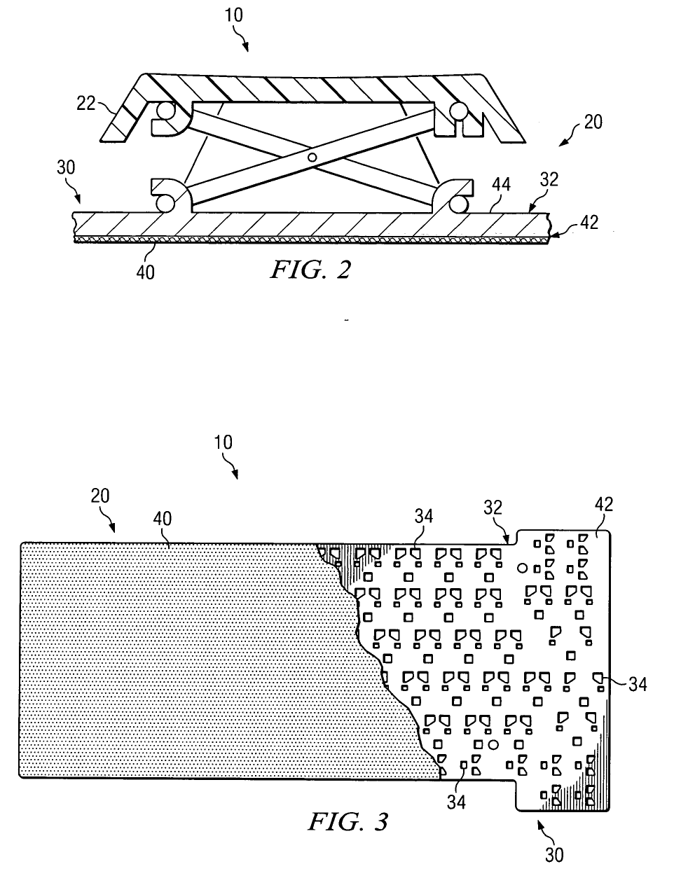

FIG. 2 is a diagram illustrating a section view of a portion of an embodiment of a keyboard barrier in accordance with the present invention taken along the line 2-2 of FIG. 1, and FIG. 3 is a diagram illustrating a bottom view of the keyboard 20 of FIGS. 1 and 2. In the embodiment illustrated in FIGS. 2 and 3, keyboard 20 comprises a base plate 30 configured to enable coupling of key caps 22 thereto. For example, in the embodiment illustrated in FIGS. 2 and 3, base plate 30 comprises a perforated base plate 32 having openings 34 disposed therein (e.g., formed by a stamping process and/or otherwise) to facilitate coupling of key caps 22 thereto and/or facilitate air flow therethrough for dissipating thermal energy generated by computer device 10 (e.g., thermal energy generated by components disposed in base member 16 of computer device 10). In the embodiment illustrated in FIGS. 2 and 3, an air-permeable barrier element 40 is disposed within computer device 10 relative to keyboard 20 to prevent (e.g., prevent or substantially prevent) liquid or moisture migration through keyboard 20 and/or migration of moisture to electronic components disposed behind and/or under keyboard 20. For example, preferably, air-permeable element 40 is configured as a gas-permeable membrane having pores sized sufficiently small to prevent liquid or moisture migration therethrough while enabling an airflow to pass therethrough such as, but not limited to, hydrophobic materials available from WL Gore & Associates, Incorporated. Accordingly, air-permeable barrier element 40 prevents moisture migration through keyboard 20 while enabling an airflow to pass through keyboard 20 to facilitate thermal dissipation of computer device 10. In FIG. 3, a portion of air-permeable barrier element 40 is illustrated as broken away for illustrative purposes (e.g., to illustrate openings 34 formed in perforated base plate 32). However, it should be understood that, preferably, air-permeable barrier element 40 extends to corresponding dimensions of base plate 30.

In the embodiment illustrated in FIGS. 2 and 3, air-permeable barrier element 40 is coupled to a side 42 of base plate 30 opposite a side 44 of base plate 30 to which key caps 22 are coupled. For example, in some embodiments of the present invention, air-permeable barrier element 40 is adhesively coupled to base plate 30. However, it should be understood that barrier element 40 may be otherwise secured to base plate 30. Further, it should be understood that air-permeable barrier element 40 may be otherwise located relative to base plate 30 (e.g., spaced apart from base plate 30 and disposed on another structural element and/or otherwise separately interdisposed between keyboard 20 and electronic components of computer device 10 which may be otherwise damaged or compromised as a result of moisture contact therewith). In the embodiment illustrated in FIGS. 2 and 3, air-permeable barrier element 40 extends across the entire dimensions (e.g., the entire width and length) of base plate 30 and/or otherwise extends to a perimeter of base plate 30 to cover all openings 34 of perforated base plate 32. However, it should be understood that air-permeable barrier element 40 may be otherwise located relative to base plate 30 (e.g., discretely positioned at one or more separate locations relative to base plate 30 where moisture migration is of a concern).

Thus, embodiments of the present invention provide a keyboard moisture barrier being low in weight, easily adaptable to the shape of a keyboard, minimal in size (e.g., taking up very little room inside a computer device) while enabling an airflow therethrough to facilitate thermal energy dissipation associated with electronic components of the computer device.

What is claimed is:

1. A computer device, comprising:
a keyboard; and
an air-permeable barrier element disposed within the computer device and configured to prevent moisture migration through the keyboard.

2. The computer device of claim 1, wherein the air-permeable barrier element is coupled to the keyboard.

3. The computer device of claim 1, wherein the air-permeable barrier element is coupled to a base plate of the keyboard.

4. The computer device of claim 1, wherein the air-permeable barrier element is coupled to a side of a base plate of the keyboard opposite a side of the base plate of a key cap of the keyboard.

5. The computer device of claim 1, wherein the computer device comprises a portable computer device.

6. The computer device of claim 1, wherein the keyboard comprises a perforated base plate, the air-permeable barrier element configured to prevent moisture migration through the perforated base plate.

7. A method of manufacturing a computer device, comprising:
providing a keyboard; and
disposing an air-permeable barrier element relative to the keyboard configured to prevent moisture migration through the keyboard.

8. The method of claim 7, further comprising coupling the air-permeable barrier element to the keyboard.

9. The method of claim 7, further comprising coupling the air-permeable barrier element to a base plate of the keyboard.

10. The method of claim 7, further comprising coupling the air-permeable barrier element to a side of a base plate of the keyboard opposite a side of the base plate of a key cap of the keyboard.

11. The method of claim 7, further comprising providing the keyboard having a perforated base plate.

12. The method of claim 11, further comprising disposing the air-permeable barrier element relative to the keyboard to prevent moisture migration through the perforated base plate.

13. The method of claim 7, further comprising disposing the keyboard and the air-permeable barrier element within a portable computer device.

14. A keyboard, comprising:
a base plate; and
an air-permeable barrier element coupled to the base plate and configured to prevent moisture migration through the base plate.

15. The keyboard of claim 14, wherein the base plate comprises a perforated base plate.

16. The keyboard of claim 14, wherein the air-permeable barrier element is coupled to a side of the base plate opposite a side of the base plate having a key cap.

17. A method of manufacturing a keyboard, comprising:
providing a base plate; and
coupling an air-permeable barrier element to the base plate configured to prevent moisture migration through the base plate.

18. The method of claim 17, further comprising coupling the air-permeable barrier element to a side of the base plate opposite a side of the base plate having a key cap.

19. The method of claim 17, wherein providing a base plate comprises providing a perforated base plate.

20. The method of claim 19, further comprising coupling the air-permeable barrier element to the base plate to cover at least one opening of the perforated base plate.
